(19) United States
(12) Patent Application Publication
(10) Pub. No.: US 2015/0007057 A1
(43) Pub. Date: Jan. 1, 2015

(54) System and Method for Application Sharing

(71) Applicants: Bin Zhu, Jiangsu Province (CN); Ling Zhang, Hefei City (CN); Guang Xu, Hefei City (CN); Yongze Xu, Hefei City (CN)

(72) Inventors: Bin Zhu, Jiangsu Province (CN); Ling Zhang, Hefei City (CN); Guang Xu, Hefei City (CN); Yongze Xu, Hefei City (CN)

(73) Assignee: CISCO TECHNLOGY, INC., San Jose, CA (US)

(21) Appl. No.: 13/932,208

(22) Filed: Jul. 1, 2013

(51) Int. Cl. H04L 29/06

(52) U.S. Cl. CPC H04L 65/403
USPC 715/753

(57) ABSTRACT

Some implementations may provide a method for application sharing over a network that includes: (i) initiating, by a first computing device, a sharing of an application between the first computing device and a second computing device, the application having a window displaying contents and the first computing device in communication with the second computing device over the network; (ii) transmitting, from the first computing device to the second computing device, data encoding the contents being displayed in the window of the application; (iii) determining whether the contents being displayed in the window of the application have been updated; (iv) in response to determining that the contents have not been updated, pre-fetching by the first computing device, at least one snap-shot of the window with contents predicted to be displayed; and (v) transmitting, from the first computing device to the second computing device, data encoding the predicted contents.

### TECHNICAL FIELD

The following disclosure relates generally to application sharing.

### BACKGROUND

Application sharing is one form of collaboration software. Application sharing may allow people to share some application with their partners through internet. Examples of shared applications may include: word document, point-point presentation slide, web page, or any given area on presenter's computer screen.

### BRIEF DESCRIPTION OF THE FIGURES

FIG. 1 is a flow-chart of application sharing between a host and an attendee.

FIG. 2 is a flow-chart of application sharing between a host and an attendee according to some implementations.

FIG. 3 illustrates a mask window capable of masking the application window according to some implementations.

FIG. 4 illustrates the mask window acting to mask the current page of contents of an application window during an on-line sharing of the application according to some implementations.

FIG. 5 is a flow chart of pre-fetching screen contents according to some implementations.

FIG. 6 shows test results of pre-fetching screen contents for sharing a pdf document.

FIG. 7 shows test results of pre-fetching screen contents for sharing a power point slide.

### DESCRIPTION OF EXAMPLE EMBODIMENTS

### Overview

Some implementations may provide a method for application sharing over a network that includes: (i) initiating, by a first computing device, a sharing of an application between the first computing device and a second computing device, the application having a window displaying contents and the first computing device in communication with the second computing device over the network; (ii) transmitting, from the first computing device to the second computing device, data encoding the contents being displayed in the window of the application; (iii) determining whether the contents being displayed in the window of the application have been updated; (iv) in response to determining that the contents have not been updated, pre-fetching by the first computing device, at least one snap-shot of the window with contents predicted to be displayed; and (v) transmitting, from the first computing device to the second computing device, data encoding the predicted contents.

### DETAILED DESCRIPTION

A presenter hosting an on-line meeting may use application sharing over the internet to allow attendees to visualize documents such as word or pdf files, power-point slides, animations, videos, web pages, etc. during the presentation on-line.

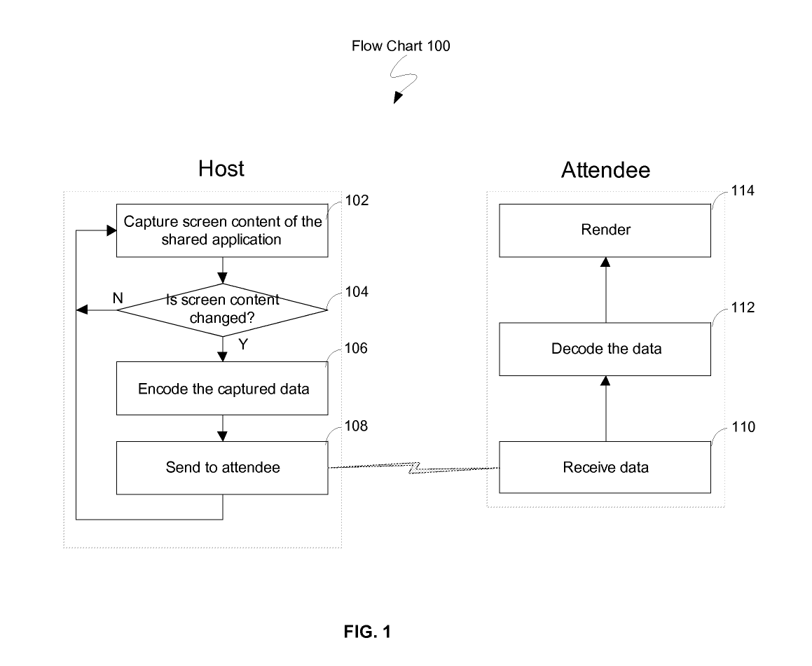

FIG. 1 is a flow chart of application sharing between a host and an attendee. An implementation of application sharing may include two end-points, namely, a host and an attendee. On the host side, the process may start with capturing a screen content of application window as a picture or video frame (102). For discussion herein, a picture or video frame may be abbreviated as a frame. A frame may be one unit of video data between the host and the attendee during an on-line application sharing. If the captured picture or video frame has changed over the preceding frame (104), the present picture or video frame may be encoded (106). Otherwise, the process may simply revert to capturing the next picture or video frame (102). The encoded captured picture or video frame may be sent to remote attendee(s) over the Internet (108). The encoding may be performed according to any video codec standard for streaming video data over the Internet, such as, for example, H.263+, H.264/MPEG-4, MPEG-2, MPEG-1, etc. The transmission may be based on transmission control protocol (TCP) or user datagram protocol (UDP). The transmission may utilize any underlying physical layer technologies in existence of being developed, such as, for example, IEEE 802.11x, Ethernet, Ethernet-2, Fast Ethernet, Gaga-bit Ethernet, 10 Giga-bit Ethernet, etc.

On the attendee side, an attendee may receive the encoded video data from the Internet during the on-line meeting session (110). The received data may then be decoding in accordance with the encoding standard (112). Thereafter, the decoded data may be rendered for display at an output device on the attendee side (114). Though the technical details of rendering methods may vary, rendering may generally be performed by the graphics pipeline along a rendering device, such as a graphics processing unit (GPU). A GPU may be a purpose-built device able to assist a central processing unit (CPU) in performing complex rendering calculations such that the rendering results may look relatively realistic and predictable under, for example, a given virtual lighting condition. The rendered results may be visualized at an output device. Example output devices may include, for example, a liquid crystal display (LCD), a light-emission diode (LED) display, an organic light-emission diode (OLED) display, a plasma display, a liquid crystal on silicon (LCOS) display, a digital light projection (DLP) display, a cathode ray tube (CRT), a projection display, a projection display etc. The output device(s) may be coupled to any computing device, such as, for example, a laptop, a personal computer (PC), a server computer, a smartphone, a personal digital assistant (PDA), etc. The output device(s) may be or may part of any computing device, such as, for example, a touch screen device.

The process of data encoding, transferring, decoding, and rendering may take time and may thus introduce an inherent delay from the perspective of application sharing over the network. When the host refreshes the screen display on the host side, the attendee(s) may not see the changes of shared content until after the encoded contents have been received, decoded, and then rendered on the output display on the attendee side. This delay can significantly impact user experience during an on-line meeting. For example, when the host announces new contents in the presentation, the attendee(s) may still be viewing the contents before the refresh. This delay can cause dissonance or frustration during an on-line presentation as participants struggling to stay on the same page.

Let Tᵣ denote the entire delay which may be expressed as:

Tᵣ=Tₑ+Tₜ+T_{d},

where Tₑ is the time for encoding the captured screen snapshot at host side, Tₜ is the time for transferring the encoded contents over network, and T_{d} is the time for decoding the encoded contents at attendee side. Tₜ may be the dominant delay factor when the network bandwidth is limited and the payload of encoded data is rather heavy. Nonetheless, from the perspective of a terminal user, the network bandwidth is fixed and generally can't be controlled by the terminal user. However, reducing the data size to be transferred may decrease Tₜ. For example, reducing the encoded frame size when shared screen content changes may improve Tₜ. Specifically, by predicting and capturing the screen contents which may be shown later, some implementations may send the pre-fetched screen contents to attendees in advance. Although the pre-fetched data can't be rendered on the attendee side in the pre-fetched state, such data can be used as a reference for encoding and decoding later frames. When a pre-fetched frame is used as a reference and the screen contents changes subsequently, the portions of the contents that have not been changed may be found in the pre-fetched data. Because the attendee has a copy of the pre-fetched data that includes the portions of the contents that have not been changed, this portion of contents may not need to be transmitted again from the host to the attendee(s). Thus, the size of the encoded frame may be reduced and consequently, the delay Tₜ may be decreased. Hence, reducing the amount of data to be transmitted may reduce the apparent latency on the attendee side from the time when the application window on the host side is updated to the time when the update is reflected on the shared application window on the attendee side.

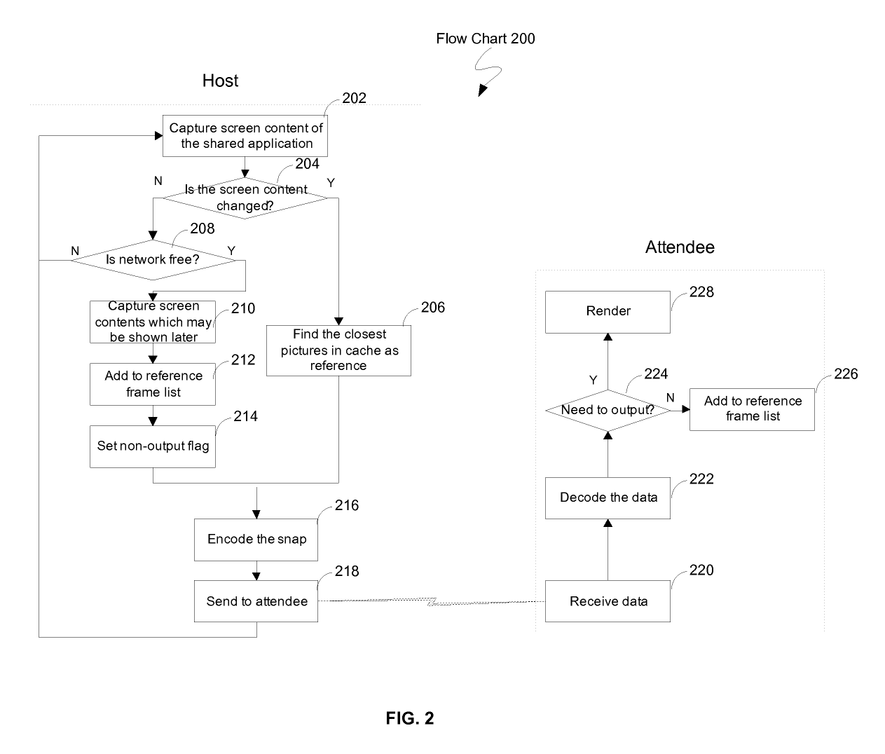

FIG. 2 is a flow chart of application sharing between a host and an attendee according to some implementations. On the host side, some implementations may start by capturing a picture or video frame of screen contents of the shared application (202).

In some implementations, when the contents have not been changed (204), screen contents of the shared application may be pre-fetched before the screen contents are updated by user input on the host side. For example, in some implementations, the screen contents to be presented may be pre-fetched while the shared screen stays unchanged. Specifically, some implementations may speculatively capture the screen contents that may be presented later (210). The captured screen contents may be in the form of a picture or video frame, as discussed above. The picture or video frame may be added to a list of reference frames for later use (212). Subsequently, the picture or video frame may be tagged “non-output” to indicate to an attendee recipient that the tagged picture or video frame is a reference frame and no rending is necessary (214). Thereafter, the tagged picture or video frame may be encoded (216) and transmitted (218) in accordance with the encoding the transmission procedures described above in association with FIG. 1.

If the contents have been changed (204), the picture or video frame in the cache on the host side that is closest to the changed screen contents may become the reference frame (206) to be used for immediate transmission of the current frame to the attendee(s). Using the reference frame, the difference between the current frame and the reference frame may be encoded (216) in accordance with any encoding standards for transmission to the attendee (218). In addition, information identifying the reference frame may also be encoded. The encoding and transmission procedures generally utilize the technologies as described above in association with FIG. 1. The use of the reference frame allows the host to transmit, when the screen contents have been determined to be refreshed, only the data contents that have been changed since transmission of the reference frame. In other words, the reference frame has been transmitted to the attendee earlier and transmitting the snapshot corresponding to the current screen contents may only entail transmitting the screen contents that have been updated. Thus, the amount of data for transmission under the circumstances of screen contents having been refreshed can be limited to a minimum amount. Therefore, the apparent latency of transmitting Tₜ can be kept low. Everything else being equal, that is, if Tₑ and T_{d} stays the same, Tᵣ can be substantially minimized.

On the attendee side, the encoded picture or video frame may be first received (220) in a network buffer of the attendee. The network buffer may be store a multitude of received picture or video frames. The received picture or video frame may be in a compressed format. The received data may be a group of received IP packets. The encoded picture or video frame may be in the payload of the received IP packets. The received IP packets may be reordered so that the payload data may be extracted to assemble the picture or video frame in the encoded form. Once assembled, the encoded picture or video frame may then be decoded (222). The decoded payload data may include the data for the picture or video frame and the tag indicating whether the picture or video frame is for output. The tag may be inspected to ascertain whether to output the tagged picture or video frame (224). If, for example, the frame is tagged as “Non-output,” then the picture or video frame will be added to a list of reference frame maintained on the attendee side (226). When added to the list of reference frames, the picture or video frame may not be rendered and displayed on the attendee side. Instead, the picture or video frame may only be stored in the list of reference frames. Conversely, if the frame is indicated as “output,” then the picture or video frame may be rendered and displayed on the attendee side (228).

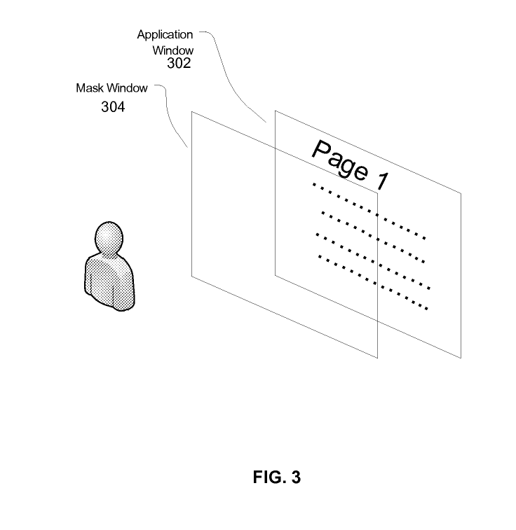

The next issue is how to capture the snapshots of screen contents on the host side without disturbing the display on the host side. To this end, a mask window may be employed in some implementations. FIG. 3 illustrates a mask window capable of masking the application window according to some implementations. The mask window may be located in front of the application window being shared. The mask window may be transparent to the user, as illustrated by FIG. 3. The mask window may be set as “inactive” so that the operating system (OS) may not deliver user input from the keyboard or mouse to the mask window. Example OS may include, but may not be limited to, a Windows operating system, a iOS, a UNIX operating system, a LINUX operating system (including Android), etc. User input may also come from other peripheral devices, such as, for example, a joy stick, a touch-sensitive screen, etc. Although the user inputs may not be reported to a mask window tagged inactive, the operating system may reroute user inputs to the application window located behind the mask window. As a result, the application window will respond to the user input as if the mask window is transparent and dormant. Thus, the user may not perceive the existence of the mask window.

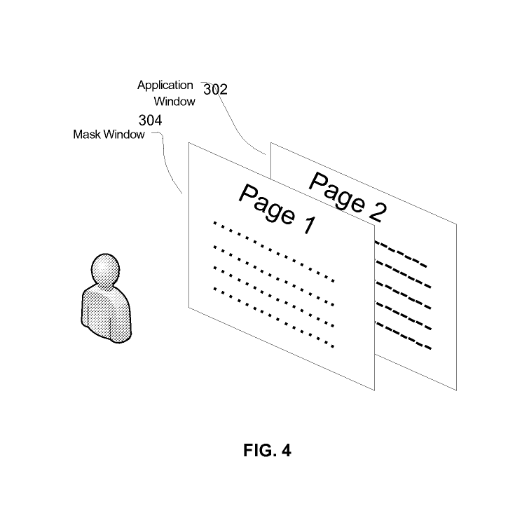

FIG. 4 illustrates the mask window acting to mask the current page of contents of the application window during an online sharing of the application according to some implementations. When pre-fetching screen contents of the application window that may be shown later during the on-line discussion, the current screen contents of the application window may be captured, for example, in a frame buffer. Then, the mask window may be set to non-transparent and the captured current screen contents from the application window may be displayed on the non-transparent mask window. Thereafter, the application window may be operated on without disturbing the display of the current screen contents being displayed to participants of the on-line sharing session, as illustrated by FIG. 4.

Specifically, to pre-fetch screen contents of the application window that may be shown next, simulated user inputs, such as, for example, mouse scroll or keyboard page-up, may be directed at the application window to bring up the screen contents. In some implementations, the simulated mouse events may be emulated events, for example, emulated events based on touch screen events, etc. For example, a simulated keyboard event of page-down corresponding to when the “Page Down” key has been pressed may be generated. The simulated page-down keyboard event may be sent to the application window now sitting behind the opaque (non-transparent) mask window. In response, the next page of screen contents from the application window may be captured while the mask window, now opaque, presents the current screen contents of the application window. When the predicted next page of screen contents have been capture, a simulated keyboard event of page-up corresponding to when the “Page Up” key is pressed may be generated and sent to the application window. In response, the application window may be flipped back to the position showing the current screen contents. The application window correspond to a document application such as, for example, an Internet Explorer browser, Firefox browser, a Google Chrome browser, a PowerPoint presentation, a Word document, an Excel sheet, a visio file, an Adobe Reader application, a media player, etc. Thus, user input may be simulated and routed to the application window at the OS application level. In this way, screen contents that may be displayed can be pre-fetched without disturning the current screen contents of the application window being displayed to the user.

Moreover, user inputs on the host side may be collected from a given peripheral on the host, for example, a keyboard, a mouse, a touch screen, a joy stick, etc. The collected user inputs may be profiled to reveal a trend of screen scrolling or flipping on the target application window. Based on the profiled user inputs, future screen movements may be predicted. In particular, the next page(s) of screen contents may indicate the screen contents of the application window to be shown next (i.e., when the current screen contents are updated by the user inputs). The predicted next page(s) may then be pre-fetched before the actual update by the user inputs. Thereafter, the pre-fetched next pages may be tagged as “non-output,” encoded, and transmitted to the attendee side according the procedure described herein.

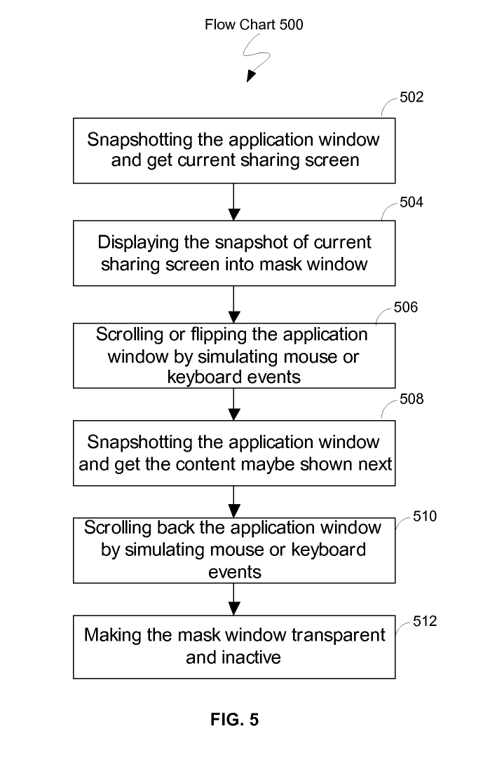

FIG. 5 is a flow chart of pre-fetching screen contents according to some implementations. A snapshot of the application window may be obtained to capture the current screen contents of the application window being shared during an on-line discussion (502). The captured current screen contents may then be displayed in the display window (504). In some implementations, the display window may then be set to opaque to shield the application window behind so that the contents thereon become invisible to participants of the application sharing. Simulated user inputs may then be generated to scroll or flip the application window behind the mask window (506). The scrolling or flipping can cause the next page(s) of screen contents of the application window to be captured, for example, in a buffer of frames (508). The buffer of frames may be located at the application level or the OS level. The captured next page(s) of screen contents may be transmitted to the attendee side before the application window on the host side gets updated by user input, as discussed above. From the perspective of pre-fetching, once the capturing of next page(s) has been accomplished, the application window behind the opaque mask window may be scrolled or flipped to revert to the earlier position before the pre-fetch (510). At this earlier position, the screen contents of the application may match the contents being displayed at the mask window. For example, simulated user inputs may be generated to scroll or flip the application window in reverse direction so that the application window may be brought back to the position where the screen contents match those displayed at the opaque window. Once the earlier position of the application window has been recovered, the mask window may be masked as transparent and inactive (512). A transparent mask window may be seen through. An inactive window may cause the operating system to suppress reporting user input, for example, from keyboard or mouse, to the mask window. The suppressed user input events may be rerouted to the application window located behind the mask window. As a result, the application window will respond to the user input as if the mask window is not there. Thus, the user may not perceive the existence of the mask window, as discussed above.

Some implementations may lead to an apparent decreased latency between the host and attendee. When application window is updated by user input on the host side, the size of encoded frame to be transmitted to the attendee size may be reduced according to some implementations. In response to the user input on the host side, the host may transmit the information indicating the reference frame to the attendee side. The reference frame may be a picture of video frame that has already been transmitted to the attendee before the update and when network bandwidth was still available. The already transmitted picture or video frame may be cached on the attendee side according to a list of reference frames. As a result, when the current contents of the application window are updated, the host may only need to transmit a portion, if any, that has changed from the closest reference frame. The reference frames cached on the attendee side all have been decoded. Therefore, the amount of data transmission can be substantially reduced. In other words, the data transmission in response to an update on the application window being shared can be kept low because the host predicts and pre-fetches the frames that may be shown later and proactively transmits the data encoding these frames over to the attendee(s) before the update and when network still has sufficient communication's bandwidth. Thus, data transmission in response to an update can be reduced and hence the delay between host and attendees can be kept to a minimum, in response to the update.

To demonstrate the improvements to application sharing, simulation tests have been conducted in which only the next one page was pre-fetched. In these simulation tests, the list of reference frames on the attendee side included the pre-fetched picture or video frame and preceding picture or video frame. As discussed herein, what matters to the perceived latency in response to an update during an on-line application sharing may include the size of frame to be transmitted from the host to the attendee. Hence, in these simulations, the size of the frame to be transmitted was the metric by which to measure the performance improvement in application sharing.

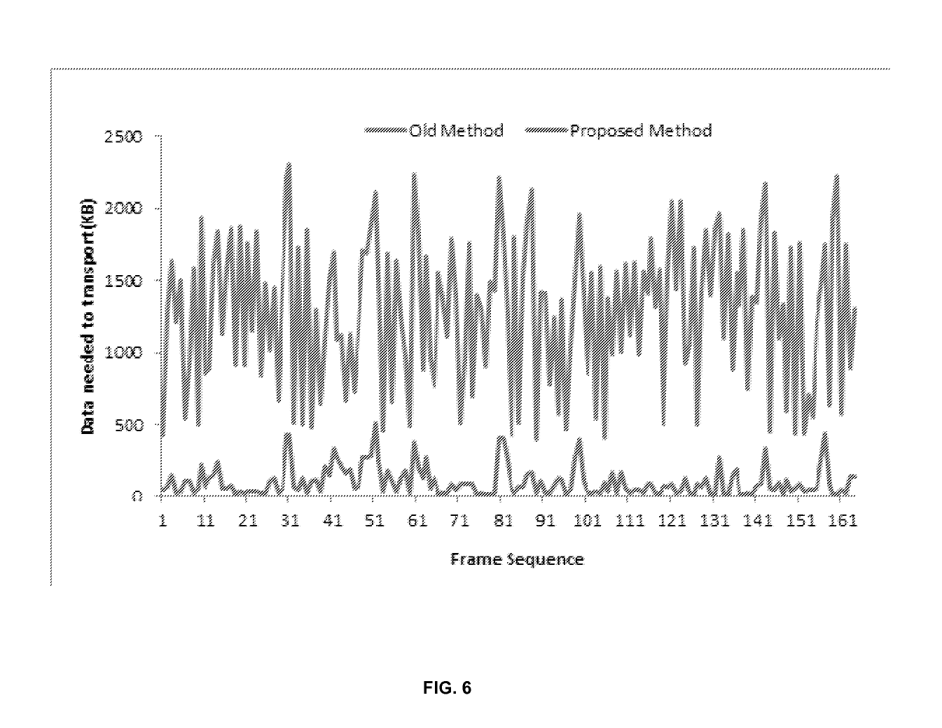

FIG. 6 shows test results of pre-fetching screen contents for sharing a pdf document. In the PDF document sharing, simulated mouse events were used to scroll the page at a normal speed to advance the pages being shown. The normal speed may generally correspond to about, for example, ⅓ page forward/backward per mouse event about five seconds. The normal speed may be faster or slower depending on the context of applications. The shared applications were set to full screen mode and the screen dimension was 1900×1200. To negate differences caused by image or video compression technology, no compression technologies were used in the comparison. For comparison, under the old method, the data size was calculated based on using only the preceding picture or video frame as reference. When encoding a frame, the lines of the frame which can be found from the reference frames were removed from the frame and the size of remaining lines were counted as the size of encoded frame to be transmitted (Proposed Method). As illustrated by FIG. 6, the amount of data to be transmitted under the proposed method was consistently much lower than under the old method. Specifically, the data to be transmitted under the proposed method tends to be perennially less than 20% of that under the old method, although the spikes of the data size under the two methods appear to correlate with each other.

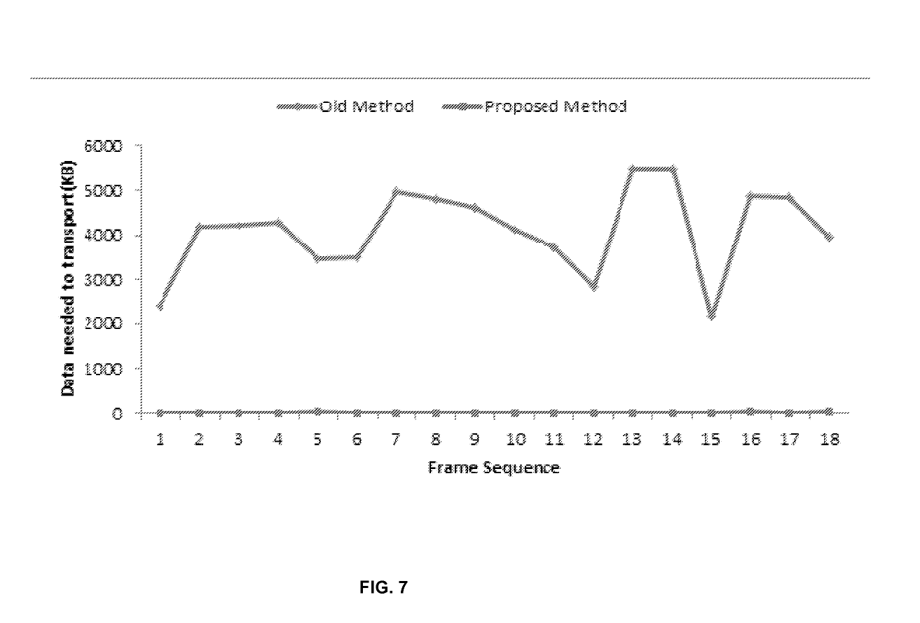

FIG. 7 shows test results of pre-fetching screen contents for sharing a power point slide. As discussed above, the simulated mouse events were used to scroll the page at a normal speed to advance the pages being shown. The shared applications were set to full screen mode and the screen dimension was 1900×1200. No compression technologies were used in the comparison. For comparison, under the old method, the data size was calculated based on using only the preceding picture or video frame as reference. When encoding a frame, the lines of the frame which can be found from the reference frames were removed from the frame and the size of the remaining lines were counted as the size of encoded frame to be transmitted (Proposed Method). As illustrated by FIG. 6, the amount of data to be transmitted under the proposed method remained at substantially zero. This may correspond to a complete cache hit in the sense that each reference page became the next page for display on the attendee's side and thus the remaining lines were zero. The complete cache hit can be due to an exact alignment of the reference frame transmitted and the next frame to be displayed. Thus, there was no need to transmit anything when the application window was updated by user input on the host side. In contrast, during the pdf sharing, the complete cache hit rarely came by and for most frames, some lines in the frame to be displayed need to be transmitted to the attendee side. Thus, the amount of savings with a shared power point slide appear much greater, as illustrated by FIG. 7.

Another aspect of improvement regards the quality of service (QoS). Because the pre-fetched data may be transmitted from the host to the attendee(s) before the actual update and when the network bandwidth has sufficient capacity to handle the additional traffic, the demand for network bandwidth at the time of the actual update may be substantially less spiky than otherwise would be the case. Moreover, the pre-fetched frames are transmitted to the attendee(s) when the network has untapped bandwidth and when the contents being presented have not changed. This means that the pre-fetched frames may be transmitted smoothly at a lower rate. Thus, the risk of network congestion caused by spiky demands for network bandwidth can be substantially mitigated and hence the QoS associated with the application sharing over the communications network may be improved.

The disclosed and other examples can be implemented as one or more computer program products, i.e., one or more modules of computer program instructions encoded on a computer readable medium for execution by, or to control the operation of, data processing apparatus. The implementations can include single or distributed processing of algorithms. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The computer program may be stored in static random access memory (SRAM) and dynamic random access memory (DRAM). The computer program may also be stored in any non-volatile memory devices such as, for example, read-only memory (ROM), erasable programmable read-only memory (EPROM), electrically erasable programmable read-only memory (EEPROM), compact disc (CD ROM), DVD-ROM, flash memory devices; magnetic disks, magneto optical disks, etc.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document describe many specifics, these should not be construed as limitations on the scope of an invention that is claimed or of what is claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features is described above as acting in certain combinations and even initially claimed as such, one or more features from a claimed combination can in some cases be excised from the combination, and the claimed combination is directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for application sharing over a network, comprising:
initiating, by a first computing device, a sharing of an application between the first computing device and a second computing device, the application having a window displaying contents and the first computing device in communication with the second computing device over the network;
transmitting, from the first computing device to the second computing device, data encoding the contents being displayed in the window of the application;
determining whether the contents being displayed in the window of the application have been updated;
in response to determining that the contents have not been updated, pre-fetching by the first computing device, at least one snap-shot of the window with contents predicted to be displayed; and
transmitting, from the first computing device to the second computing device, data encoding the predicted contents.

2. The method of claim 1, further comprising:
receiving, at the first computing device, user input causing updates of the contents being displayed in the window of the application;
based on the user input, determining a trend of the user input.

3. The method of claim 2, further comprising:
predicting the contents to be displayed in the window of the application in accordance with the determined trend of user input.

4. The method of claim 1, wherein transmitting data encoding the predicted contents comprises transmitting the data to the second computing device without displaying the predicted contents at the first computing device.

5. The method of claim 1, further comprising:
tracking each of the at least one pre-fetched snapshot that has been transmitted.

6. The method of claim 5, further comprising:
in response to determining that the contents have been updated, obtaining a pre-fetched snapshot of the window with contents that are closer to the updated contents than the contents being displayed before the determined update.

7. The method of claim 5, further comprising:
notifying the second computing device of the update by transmitting information encoding the obtained pre-fetched snapshot.

8. A computing device, comprising:
one or more processors; and
logic encoded in one or more tangible non-transitory machine-readable media for execution on the one or more processors, and when executed causes the one or more processors to perform a plurality of operations, the operations comprising:
initiating a sharing of an application between the computing device and another computing device, the application having a window displaying contents and the first computing device in communication with the another computing device over a network;
transmitting to the another computing device data encoding the contents being displayed in the window of the application;
determining whether the contents being displayed in the window of the application have been updated;
in response to determining that the contents have not been updated, pre-fetching at least one snap-shot of the window with contents predicted to be displayed;
transmitting data encoding the predicted contents to the another computing device.

9. The computing device of claim 8, wherein the operations further comprise:
receiving user input causing updates of the contents being displayed in the window of the application;
based on the user input, determining a trend of the user input.

10. The computing device of claim 9, wherein the operations further comprise:
predicting the contents to be displayed in the window of the application in accordance with the determined trend of user input.

11. The computing device of claim 8, wherein transmitting data encoding the predicted contents comprises transmitting the data to the another computing device without displaying the predicted contents at the computing device.

12. The computing device of claim 8, wherein the operations further comprise:
tracking each of the at least one pre-fetched snapshot that has been transmitted.

13. The computing device of claim 12, wherein the operations further comprise:
in response to determining that the contents have been updated, obtaining a pre-fetched snapshot of the window with contents that are closer to the updated contents than the contents being displayed before the determined update.

14. The computing device of claim 12, wherein the operations further comprise:
notifying the second computing device of the update by transmitting information encoding the obtained pre-fetched snapshot.

15. A non-transitory computer-readable medium comprising instructions to cause a processor to perform operations comprising:
initiating a sharing of an application between the computing device and another computing device, the application having a window displaying contents and the first computing device in communication with the another computing device over a network;
transmitting to the another computing device data encoding the contents being displayed in the window of the application;
determining whether the contents being displayed in the window of the application have been updated;
in response to determining that the contents have not been updated, pre-fetching at least one snap-shot of the window with contents predicted to be displayed;
transmitting data encoding the predicted contents to the another computing device.

16. The non-transitory computer-readable medium of claim 15, wherein the operations further comprise:
receiving user input causing updates of the contents being displayed in the window of the application;
based on the user input, determining a trend of the user input.

17. The non-transitory computer-readable medium of claim 15, wherein the operations further comprise:
predicting the contents to be displayed in the window of the application in accordance with the determined trend of user input.

18. The non-transitory computer-readable medium of claim 15, wherein transmitting data encoding the predicted contents comprises transmitting the data to the another computing device without displaying the predicted contents at the computing device.

19. The non-transitory computer-readable medium of claim 15, wherein the operations further comprise:
tracking each of the at least one pre-fetched snapshot that has been transmitted.

20. The non-transitory computer-readable medium of claim 19, wherein the operations further comprise:
in response to determining that the contents have been updated, obtaining a pre-fetched snapshot of the window with contents that are closer to the updated contents than the contents being displayed before the determined update; and
notifying the another computing device of the update by transmitting information encoding the obtained pre-fetched snapshot to the another computing device.
